(19) United States
(12) Patent Application Publication
(10) Pub. No.: US 2003/0084788 A1
(43) Pub. Date: May 8, 2003

(54) Foam coated air filtration media

(76) Inventor: Ladson L. Fraser JR., High Point, NC (US)

Correspondence Address: Finnegan, Henderson, Farabow,, Garrett & Dunner, L.L.P., 1300 I Street, N.W., Washington, DC, 20005-3315, US

(21) Appl. No.: 10/176,896

(22) Filed: Jun. 21, 2002

Related U.S. Application Data
(60) Provisional application No. 60/299,742, filed on Jun. 22, 2001.

(51) Int. Cl. B01D 46/00

(52) U.S. Cl. 95/285; 55/486; 95/287; 55/524; 55/525; 55/527; 55/528

(57) ABSTRACT

The present invention provides an air filter made from a composite comprising a substrate and a polymeric foam. The air filter can comprise a single layer. The foam has a density gradient where the lower density upstream portion of the filter can trap larger particles, allowing smaller particles to penetrate into the filter and be trapped by the higher density downstream portion of the filter. The density gradient arises from intercalation of the polymeric foam with the substrate. The composite design provides comparable or improved filtration efficiencies compared to the complex prior art air filters which rely on multiple layers to provide a density gradient.

### DESCRIPTION OF THE INVENTION

1. Related Applications

The present application claims the benefit of priority under 35 U.S.C. §119 based on U.S. Provisional Application No. 60/299,742 filed Jun. 22, 2001.

2. Field of the Invention

The present invention relates to composite air filters, which can comprise a porous substrate, at least a portion of which is intercalated with a polymeric foam. Filters according to the present invention comprise a density gradient across its thickness.

### BACKGROUND OF THE INVENTION

Air filtration media are useful for removing particulate contaminants from domestic and industrial environments. Much attention has been devoted to producing cost-efficient air filters having adequate or improved filtration efficiencies that fulfill the ASHRAE (American Society of Heating, Refrigeration and Air-conditioning Engineers) and SAE (Society of Automotive Engineers) requirements for various filter end use specifications.

Many current air filters provide improved initial filtration efficiencies with multi-layered composites to achieve a density gradient along the airflow pathway. If a filter had a consistent density throughout the entire material, particulate contaminants could quickly accumulate and cake on the upstream surface of the filter, thereby clogging the filter and substantially reducing, if not eliminating, airflow through the filter. In contrast, a filter with a density gradient is capable of trapping larger particles at the upstream surface or region while allowing smaller particles to penetrate through the filter to be trapped downstream. By this mechanism, it has been demonstrated that clogging and caking occurs much more slowly.

Accordingly, current filter manufacturers achieve a density gradient by positioning at least one layer upstream having a low material density, i.e., having high porosity. The highly porous layer traps only the larger particles upstream. Subsequent layers positioned adjacent the have increasing material density, i.e., decreasing porosity. As a result, the downstream layers eventually trap smaller contaminants that penetrate the upstream layers. These composites are often referred to as “depth-type media.”

Manufacturers of depth-type media seek to accomplish relatively high initial filtration efficiency and final filtration efficiency. “Initial filtration efficiency” represents the early life performance of the filter whereas “final filtration efficiency” relates to the useful life of the filter in keeping out the contaminants. Initial filtration efficiencies are relatively low, usually because smaller particles are not always trapped. The filtration efficiencies improve as particles begin to accumulate on the media, where the accumulated or caked contaminants act in themselves to filter out incoming particles. Thus, the upstream components, once saturated by the contaminant loading or caking, positively affect the final filtration efficiencies. The downstream components mostly control the early filtration of the smallest contaminants until caking or saturation occurs, which increases the efficiency of the filter media with time and loading.

It has been found that adequate initial filtration efficiencies are generally obtained through a layer with low porosity and high density in comparison to the upstream layers of higher porosity and lower density, i.e., a density gradient. Layers of different materials are laminated or otherwise assembled together to create the multi-layered constructions. Multi-layered constructions, however, continue to suffer several deficiencies. Often, costly porous films require laminating for small particle filtration. Changing process variables can be difficult, as different specified materials need to be considered. Multiple raw materials and processes are required for the different types of layers, resulting in increased non-uniform product quality. The manufacturing is complex as multiple layers and substrates are required to produce the composite. Multiple processing stages are required, resulting in low manufacturing speeds and high costs. Such processes include: mechanically attaching layers by perforation; laminating layers with adhesives, thus adding useless basis weight to the composite; and developing triboelectric charge on the media.

Thus, there remains a need to develop new air filtration media with simpler manufacturing processes and lower costs while maintaining acceptable filtration efficiencies.

### SUMMARY OF THE INVENTION

The present invention provides, generally, an air filter featuring a density gradient.

One aspect of the present invention provides an air filter comprising a porous substrate. A portion of the substrate is intercalated with a polymeric foam. The filter has a downstream side and a density gradient across its thickness.

Another aspect of the present invention provides a composite comprising a porous substrate layer and a polymeric foam permeating throughout one side of the substrate layer. The composite has a density gradient across its thickness. The composite is capable of filtering airborne particles.

Another aspect of the present invention provides an air filter comprising a fibrous substrate and a polymeric foam intercalated with fibers of the substrate. The filter has a density gradient across its thicikness.

Another aspect of the present invention provides a method for filtering air. The method comprises allowing air comprising airborne particles to pass through a single layer composite. The composite comprises a porous substrate and a polymeric foam intercalated with one side of the substrate layer. The composite has a density gradient across its thickness.

Another aspect of the present invention provides a method of making an air filter comprising providing a porous substrate layer and applying a layer of a prepolymeric foam to the substrate layer. The method also comprises drying and curing prepolymeric foam to produce a polymeric foam interspersed throughout at least a portion of the substrate.

Another aspect of the present invention provides an air filter comprising a single porous layer having a density gradient across the thickness of the layer.

Another aspect of the present invention provides an air filter comprising a porous substrate that is intercalated with a polymeric foam. The filter has a density gradient across its thickness.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 shows schematic diagrams comparing (a) the single-layer construction of a filter of Example 1 according to the present invention, with two prior art multiple-layer filters (b) Incumbent 1 and (c) Incumbent 2;

FIG. 2 is an SEM micrograph at 60X, featuring the top or downstream side view of the air filter of Example 1;

FIG. 3 is an SEM micrograph at 40X, showing the downstream side at the photo top, featuring the gradient density foam structure on and in the nonwoven substrate of Example 1;

FIG. 4 is an SEM micrograph at 60X, showing the top or downstream view of the air filter of Example 1;

FIG. 5 is an SEM micrograph at 100X, showing a microtomed side view of the downstream side of the air filter of Example 1, and featuring the gradient density foam structure on and in the nonwoven substrate;

FIG. 6 is a graph plotting initial % efficiencies for fine dust (y-axis) versus the particle size range filtered (x-axis), of the filter of Example 1, Incumbent 1 and Incumbent 2;

FIG. 7 is a graph plotting final % efficiencies for fine dust (y-axis) versus the particle size range filtered (x-axis), of the filter of Example 1, Incumbent 1 and Incumbent 2;

FIG. 8 is a graph plotting initial % efficiencies for coarse dust (y-axis) versus the particle size range filtered (x-axis), of the filter of Example 1, Incumbent 1 and Incumbent 2; and

FIG. 9 is a graph plotting final % efficiencies for coarse dust (y-axis) versus the particle size range filtered (x-axis), of the filter of Example 1, Incumbent 1 and Incumbent 2.

### DESCRIPTION OF THE EMBODIMENTS

One aspect of the invention provides an air filter comprising a porous substrate. A portion of the substrate is intercalated with a polymeric foam. The air filter features a density gradient across the thickness of the filter.

“Air filter” as used herein, refers to a porous material capable of separating airborne contaminants from air. In the filtering process, the contaminated air is forced through a porous media, which traps the contaminants and prevents them from flowing through the media. In one embodiment, airbtorne contaminants can comprise particles having a size of at least 0.1 μm. Airborne particles can include tobacco smoke, which can comprise particles as small as 0.1 μm. Larger airborne particles include beach sand, which can have a size of 1000 μm or even greater.

“Polymeric foam” as used herein, refers to a porous polymer having a plurality of pores and cavities dispersed throughout the polymer. Typically, polymeric foams are produced by aerating a solution or dispersion comprising the monomer, referred to herein as a “prepolymeric foam.” The prepolymeric foam is a liquid-like substance, which can be applied onto the substrate as a layer of any desired dimension. The prepolymeric foam comprises a plurality of micelle bubbles dispersed throughout the liquid. The sizes of the micelle bubbles eventually define the pore or cavity size of the polymeric foam, which in turn define the sizes of particles that can be filtered from the air. The pores or cavities in the polymeric foam are interconnected to create tortuous pathways for airflow throughout the foam.

While the prior art achieves a density gradient through the use of multiple layers, as described previously, this aspect of the present invention features a density gradient through a single layer. “Density gradient” as used herein refers to an increase or decrease in density upon traversing the thickness of the filter or composite. In one embodiment, the density increases when progressing downstream. Conversely, the porosity of the filter or composite decreases when progressing downstream. The thickness is the dimension parallel to the general direction of airflow, i.e., the macroscopic direction, because the air flow pathway at the microscopic level can be tortuous.

In one embodiment, a portion of the substrate is intercalated with a polymeric foam. “Intercalated” as used herein refers to the polymeric or prepolymeric foam existing between elements of the porous substrate. For example, the foam can be present throughout cavities of the substrate. Where the substrate is fibrous, the foam can intercalate with fibers of the substrate. Alternatively stated, the foam can impregnate the porous substrate, or can be interspersed with the substrate, or a portion of the substrate.

The extent of intercalation can determine the density of the resulting filter media. Without wishing to be bound by any theory, the density gradient along the foam thickness can be explained by the different shearing forces experienced by the pre-polymeric foam. As the prepolymeric foam penetrates through the porous substrate, the interaction with the substrate causes shearing forces to be applied to the foam. The cells of the foam that mechanically interact with the interface open up to form a foam of higher porosity, or lower density. The front of the applied foam will experience more shearing forces as it penetrates deeper into the substrate, and thus produces pores of greater sizes than the cells that do not penetrate very much into the substrate, which experience minimal shearing forces and generate smaller pore sizes. Drying and curing the intercalated prepolymeric foam causes polymerization to occur, which can lead to the cells opening up even more.

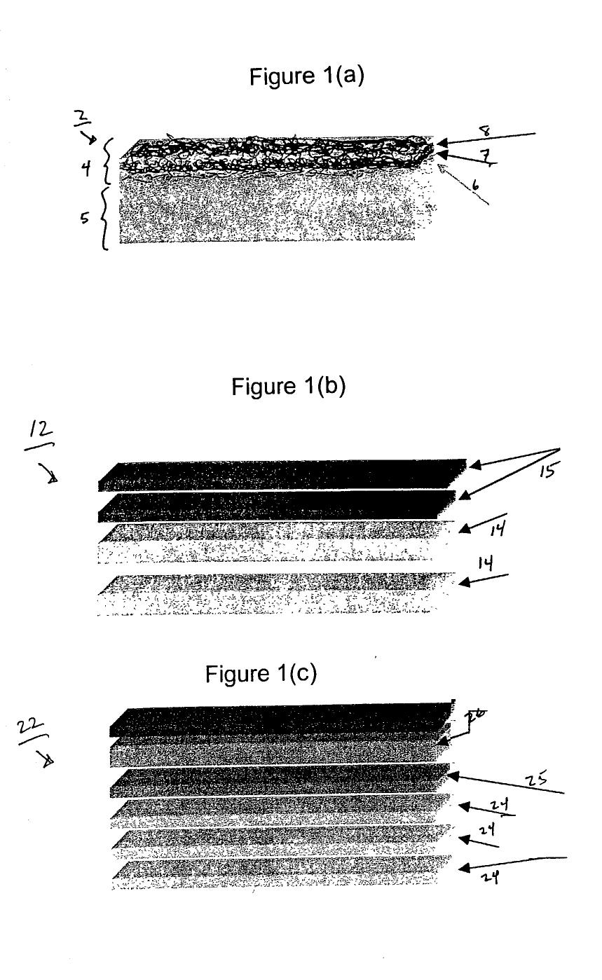

FIG. 1(a) schematically shows a side view of one embodiment of a single-layer filter of the invention. In FIG. 1(a), filter 2 (see, for example, the filter made in Example 1) comprises a single layer having one side or face, portion 4, intercalated with a polymeric foam. Portion 5 encompasses the remaining portion of filter 2 that is nonintercalated. Portion 5 is the low density region of the foam (high porosity) and when used, will be positioned upstream with respect to air flow. Because portion 4 is intercalated with foam, it is a higher density structure, where regions region 6-8 represent filter media of increasingly higher densities. FIG. 1(a) exemplifies how the substrate can also contribute to the density gradient of the overall composite, where the nonintercalated portion 5 provides the lowest density media. In one embodiment, the thickness of the intercalated portion ranges from about 5% to about 80% the thickness of the filter. The thickness can be measured, for example, by microtome photograph. In another embodiment, the thickness of the intercalated portion ranges from about 5% to about 60% the thickness of the filter.

In one embodiment, a sufficient amount of polymeric foam is provided to allow the foam to intercalate throughout substantially the entire substrate. The foam that has penetrated the entire thickness of the substrate layer can provide the most porous structure (lowest density region).

Thus, the present composite achieves a density gradient in one layer where prior art materials required several layers. Single-layer composites are easier to manufacturer because the processes necessary for assembling and joining multiple layers are eliminated. Additionally, the manufacturing costs are decreased.

In one embodiment, the density gradient is determined by measuring the density on the upstream side of the substrate versus the downstream side. In one embodiment, the density of the downstream portion, or the intercalated portion, is greater than the density of the upstream side or nonintercalated portion by about 5% to about 50%, such as greater than by about 5% to about 40%.

The upstream region or nonintercalated portion has the highest porosity of the filter or composite. In one embodiment, the upstream region or nonintercalated portion comprises pores having a mean pore size of at least about 50 μm, such as from 50 μm to 1000 μm, from 50 μm to 500 μm, or from 50 μm to 150 μm. Pore sizes can be measured according to ASTM E 1294. In one embodiment, the downstream region or intercalated portion of the filter comprises pores having a mean pore size of less than about 50 μm, such as pore sizes ranging from 0.3 μm to 50 μm, such as from 0.3 μm to 25 μm, or from 0.3 μm to 10 μm.

In yet another embodiment, particles having a size of less than 10 μm can pass through the upstream region, i.e., the upstream region has an average pore or cavity size allowing particles less than 10 μm to pass through to the downstream region, where the smaller particles are targeted. One aspect of the invention provides a method for filtering air, comprising airborne particles by passing the air through the single-layer composite filter, as described herein. In one embodiment, the air is first passed through the nonintercalated or lowest density portion of the filter. Due to the higher porosity of this region, small particles, such as particles having a size less than 10 μm, can pass through to the higher density region.

The filter should have a permeability sufficient to allow an appreciable air flow through the media. In one embodiment, the filter has a Frazier air permeability ranging from 20 to 400 ft³/min/ft² at 125 pascal, as measured according to INDA 70.0. In another embodiment, the filter has a Frazier air permeability ranging from 50 to 150 ft³/min/ft² at 125 pascal.

In one embodiment, the thickness of the filter ranges from 5 to 200 mils, as measured according to INDA 120.0. In another embodiment, the thickness of the filter ranges from 50 to 150 mils, as measured according to INDA 120.0.

Another aspect of the invention provides a method of making an air filter. The method comprises providing a porous substrate layer and applying a layer of a prepolymeric foam to the substrate layer. The foam is then dried and/or cured to produce a polymeric foam interspersed throughout at least a portion of the substrate.

Many polymeric foams are known in the art. The foam can be produced by aerating a solution or dispersion comprising a monomer. In one embodiment, the ratio of air to monomer ranges from 3:1 to 20:1. In another embodiment, the solution or dispersion can be charged with an inert gas, as is known in the art. The solution can be aerated in a mechanical foamer, such as an Oakes foamer, a Textilease foamer, or a L.E.S.S. (Latex Equipment Sales and Service, Inc.) foamer. If the foam is to be applied on a small scale, a hand mixer can accomplish the aeration, such as a Hobart or Kitchen-aid mixer. The porosity of the resulting polymeric foam can also be controlled by the extent of aeration, such as by controlling the pre-polymeric foam density with the speed of mixing or aeration.

After aeration, the pre-polymeric foam can be applied to the substrate. Typically, the pre-polymeric foam is a wet though stable structure. The pre-polymeric foam can be applied to the substrate at a desired thickness while conforming to the shape of the substrate. When applied to the porous substrate, the wet prepolymeric foam can impregnate into or intersperse throughout at least a portion the substrate without severe deterioration of the micelle bubbles that are formed in the prepolymeric foam upon aeration.

The prepolymeric foam can be applied to one face of the substrate by a number of various techniques, including coating or dipping the substrate through the prepolymeric foam. Exemplary coating techniques include knife over roll coating, knife over table coating, knife over gap, knife over blanket, floating knife, air knife, gapped pad, or slot type coater head (Gaston Systems CFS Technology).

The viscosity of the pre-polymeric foam that is applied to the substrate can range from 50 to 20,000 cps as measured at 72° F. with a #1 to #7 spindles at 20 rpm via a viscometer, Brookfield model RVT. The application temperature of the pre-polymeric foam can range from 60 to 120° F.

The polymeric foam can comprise polymers such as polyacrylic, melamine, polyvinyl acetate, polyvinyl chloride, polyurethane, polystyrene butadiene copolymers, polyacrylonitriles, polyethylene vinylacetate, polyethylene vinyl chloride, water-based epoxy, water-based phenolic resins, water-based emulsion polymers. The foam can comprise from 20% to 70% polymeric resin.

The monomeric solution or dispersion prior to aeration can also comprise fillers, thickeners, foaming stabilizers, cross-linking resins, catalysts for polymerization or cross-linking, and other ingredients such as those ingredients to modify the properties of the resulting foam.

The foam can comprise fillers in an amount ranging from 0% to 1000 weight % of polymer solids relative to the polymer solid amount. Exemplary fillers include clay, talc, TiO₂, mica, zeolite, diatomaceous earth, pyrophyllite, hydrated alumina, silica, activated charcoal, carbon black, coloration pigment grinds, flame retardants such as decabromodiphenyl oxide, antimony trixoxide, magnesium oxide, polyphosphates, phosphorus pentoxide, chlorinate paraffin, melamine powder, and blends thereof.

The pre-polymeric foam can further comprise a catalyst ranging from 2% to 5% relative to the total weight of the composition.

The blow ratio, or final air volume to wet solids volume before aeration, can range from 2:1 to 8:1.

Polymerization occurs upon drying and/or curing the pre-polymeric foam. Drying and/or curing can be performed with a tenter frame, an infrared dryer, a drum dryer, or a belt dryer. Drying temperatures can range from 150° F. to 430° F. Curing temperatures can range from 250° F. to 450° F. The drying and/or curing dwell time can be at least 25 seconds. Those of ordinary skill in the art can select the temperatures and dwell times necessary to provide a suitable composite. The prepolymeric foam comprises micelle bubbles in the form of closed cells. Upon drying in an oven, polymerization occurs resulting in the wet closed cells forming open structural pores.

The substrate can be needlepunched, spunlaced, hydroentangled, melt blown, spunbonded, thermal bonded, point bonded, resin bonded, airlaid, and combinations or composites thereof, such as spunbonded meltblown spun bonded (SMS), or spunbonded and needlepunched (SNP).

Exemplary non-woven substrates include needled felts made from polyester, polypropylene, viscose, rayon, polyethylene, and aramids; needled spun-bonded polyester; spunlace PET, Nomex®, and Kevlar®; spunbonded nonwovens made from PET, nylon, polypropylene, and polyethylene; thermally bonded nonwovens; and resin bonded nonwovens. Those of ordinary skill in the art would recognize other substrates and fiber types that would be acceptable, depending on pricing and fitness for use in air filter applications, such as the ability to be coated with a polymer foam, reasonable cost, etc.

In one embodiment, the substrate is non-woven. One example of a non-woven substrate is a needle-punched substrate, which are needled from one side, resulting in a side that is denser or smoother than the other. In one embodiment, the foam is coated on the smoother side, leaving the lower density rough side as the upstream gradient in the resulting air filter.

In one embodiment, the substrate is fibrous. An air filter comprising the fibrous substrate can further comprise a polymeric foam intercalated with fibers of the substrate to provide a density gradient across the thickness of the filter.

The basis weight of the substrate can range from about 0.5 oz/sq. yard to about 20 oz/sq. yard.

Exemplary materials for the substrate include polyester, polyolefins such as polyethylene and polypropylene, nylon, cotton and natural cellulosic fibers, rayon, carbon, acetate, polyphenylene sulfide, polyacrylic, modacrylic, glass, aramid, fluorocarbon, polybenzimidazole, polyvinyl alcohol, animal hair such as wool, silk, fibers produced from corn by-products, polyacrylonitrile, or blends thereof.

The fiber denier of the substrate can comprise all available deniers, as understood by those of ordinary skill in the art, including microdenier.

In one embodiment, one face of the substrate is coated with the foam and the opposing face is coated with a film to provide a finish. The finish can provide dimensional stability, if necessary. In other embodiments where the substrate is sufficiently stable on its own, the opposing face can remain uncoated. In one embodiment, the finish can provide an additional basis weight to the resulting composite in an amount ranging from 0.25 oz./sq. yd to 3.0 oz./sq. yd.

The resulting composite can be crushed, calendered and/or treated with other components to modify the properties. Such property modifiers include water repellants, biocides, fungicides, deodorizers, tackifiers, antistats, oleophilic agents, oleophobic agents, flame retardants, antioxidants, U.V. stabilizers, pigmentation dyes or prints, triboelectric constructions, corona or plasma treatments, and gas adsorption agents. The property modifiers can be applied by the following techniques: dip and nip pad, kiss roll (one or both sides), spray booth (one or both sides), and froth finishing applicators, such as Gaston Systems CFS Technology. Such post treatment drying and curing temperatures are well known to those skilled in the art.

The present air filter can provide at least one of the following advantages: pleatability; lower cost compared to other composites at similar relative performance levels; moisture resistance; heat resistance; solvent resistance; moldability; high efficiencies for coarse and fine particles; improved initial efficiencies; and controllable pore sizes.

If all of the required finished composite properties are not achieved during the coating process, a pre- or post-finish may be applied. This finish may comprise resins, polymer latex, water repellants, antimicrobials, deodorizers, antistats, flame retardants, tackifiers, colorants, other normally applied treatments, and combinations thereof.

Table 1 provides exemplary ingredients and amounts for a foam prior to curing.

TABLE 1

| | DRY | WET |
|---|---|---|
| INGREDIENT | PARTS | PARTS |
| 40-50% Aq. polymer dispersion | 100 | 200 |
| e.g. Rohm and Haas TR407, B F Goodrich | | |
| Hycar 26-1475 | | |
| Filler | 60-160 | Not |
| Clay; Talc, TiO2, Pigment, Activated | | applicable |
| charcoal, Decobromyl diphenyl oxide, | | |
| Antimony trioxide, Barium sulfate | | |
| Synthetic thickener | 0.25-1.5 | 0.5 to 4.5 |
| Rohm and Haas ASE60, 75, 95; National | | |
| Starch Alcogum series | | |
| Foaming Stabilizer | 3-10 | 8-30 |
| Ammonium stearate; Ammonium laurel | | |
| sulfate, Dioctyl sulfosuccinate, | | |
| Ethoxalated alcohol surfactants | | |
| Cross-linking resin | 2.5-10 | 5 to 12 |
| Melamine resin: Aerotex M3, Cymel 3030 | | |
| Catalyst | 0.25-0.7 | 1-28 |
| Ammonium chloride, Oxalic acid, Magnesium | | |
| chloride, Ammonium sulfate | | |
| Property modifiers | As needed | As needed |
| Water repellants | | |
| Biocides | | |
| Fungicides | | |
| Deodorizers | | |
| Tackifiers | | |
| Detackifiers | | |
| Antistats | | |
| Oleophilic agents | | |
| Oleophobic agents | | |
| Flame retardants | | |
| Antioxidants | | |
| U.V. stabilizers | | |
| Pigmentation - dye or print | | |
| Gas adsorption agents | | |

Table 2 lists exemplary, non-limiting, physical properties for an air filter according to the present invention.

TABLE 2

| TEST | METHOD | UNIT | Values |
|---|---|---|---|
| BASIS WEIGHT | INDA 130.0 | OZ./SQ. YD. | 2 to 16 |
| THICKNESS | INDA 120.0 | MILS | 5 to 200 |
| FRAZIER AIR | INDA 70.0 | Cubic Ft./minute/ | 20 to 400 |
| PERMEABILITY | | Sq. ft. at 125 pasc. | |
| HANDLEOMETER | INDA 90.0 | GRAMS MD | 400 to 5000 |
| 8 × 8 1″ GAP | | GRAMS XD | 400 to 5000 |
| EQUIVALENT | | | |
| GRAB TENSILE | INDA 180.2 | LBS. MD | 10 to 400 |
| | | LBS. XD | 10 to 400 |
| MEAN PORE | ASTM E 1294 | MICRONS | 1 to 150 |
| DIAMETER | | | |
| (Auto capillary flow | | | |
| porometer) | | | |

Tables 3 and 4 list exemplary initial and final efficiency ranges for filtering coarse and fine particles of various sizes. The efficiencies achieved demonstrate that the air filter of the present invention can cover a wide range of possible end uses and grades for SAE and ASHRAE air filters. The air filter can be designed to reflect fitness for use in these ranges.

TABLE 3
Test Method: Retention and Capacity per ASHRAE 52.2, modified
Instrumentation: 1230 sensor, S/N 93100199
Fluid: air
Flow rate: Face velocity: 25 fpm
Temperature: ambient
Contaminant: KCl for efficiency; ASHRAE dust for loading
Description of samples: Flat sheet media

| Particle | Initial | Initial | Final | Final |
|---|---|---|---|---|
| size range- | efficiency | efficiency | efficiency | efficiency |
| microns | % | % | % | % |
| | coarse | fine | coarse | fine |
| 0.3-0.4 | 4 to 99 | 17 to 99 | 75 to 99 | 80 to 99 |
| 0.4-0.5 | 7 to 99 | 15 to 99 | 75 to 99 | 80 to 99.5 |
| 0.5-0.6 | 10 to 99 | 20 to 99 | 75 to 99 | 80 to 99.6 |
| 0.6-0.8 | 11 to 99 | 20 to 99 | 75 to 99.5 | 80 to 99.6 |
| 0.8-1.0 | 15 to 99 | 20 to 99 | 75 to 99 | 80 to 99.4 |
| 1.0-3.0 | 15 to 99 | 20 to 99 | 50 to 99 | 80 to 99.4 |
| 3.0-5.0 | 30 to 99 | 30 to 99 | 50 to 99 | 80 to 99.4 |

TABLE 4
Test Method: Retention and Capacity per ASHRAE 52.2, modified
Instrumentation: 1230 sensor, S/N 93100199
Fluid: air
Flow rate: Face velocity: 25 fpm
Temperature: ambient
Contaminant: KCl for efficiency; ASHRAE dust for loading
Description of samples: Flat sheet media

| | Initial | Final |
|---|---|---|
| Particle | efficiency | efficiency |
| size range- | % | % |
| microns | ASHRAE | ASHRAE |
| 0.3-0.4 | 5.0 to 99 | 45 to 99 |
| 0.4-0.5 | 7.0 to 99 | 60 to 99 |
| 0.5-0.6 | 10 to 99 | 70 to 99 |
| 0.6-0.8 | 12 to 99 | 80 to 99 |
| 0.8-1.0 | 15 to 99 | 80 to 99 |
| 1.0-3.0 | 17 to 99 | 80 to 99 |
| 3.0-5.0 | 40 to 99 | 80 to 99 |

### EXAMPLE 1

An exemplary air filter according to the present invention is described here.

The substrate was a single layer greige polyester needle-punched nonwoven (NPPET) substrate. Table 5 lists the physical properties of the NPPET.

TABLE 5
Ref 000-15143 single layer greige polyester needle-punch nonwoven
(NPPET)

| Test | Method | Units | Results |
|---|---|---|---|
| Basis weight | INDA 130.0 | Oz./sq. yd | 8.22 |
| Thickness | INDA 120.0 | inches | 0.108-0.118 |
| Air Permeability | INDA 70.0 | Cubic ft./minute/ | 244 |
| | | sq. ft. | |
| Construction type | Not applicable | Not applicable | Needled felt |
| Fiber size | | denier | 60% 6 denier.; |
| | | | 40% 3 denier |

The substrate was subjected to a spray finish on the rougher upstream side, to stabilize the substrate to a desired stiffness and pleatability. Table 6 lists the components for the spray formulation. The spray compound was applied at 40 to 46% wet pickup on the upstream side to deliver 10 to 12% dry add-on to the weight of the fabric.

The smoother downstream side was coated with the wet foam formulation by a knife over foam pad process. The foam components are also listed in Table 6.

TABLE 6

| | WET PARTS | |
|---|---|---|
| INGREDIENTS | 100 parts | DRY PARTS |
| Spray formulation | | |
| Defoamer | 0.23 | 0.10 |
| Rhoplex TR 407 acrylic latex | 47.07 | 21.42 |
| Aerotex M3 crosslinking resin | 4.5 | 3.6 |
| Aqueous ammonia | 0.46 | 0.14 |
| Dioctyl sodium sulfosuccinate | 0.46 | 0.28 |
| surfactant | | |
| Oxalic acid anhydrate | 0.06 | 0.04 |
| water | 47.22 | Na |
| Coating compound | | |
| *MW3328(B F GOODRICH) | 99.94 | 49.97 |
| Graphtol Blue 6825 pigment | .06 | .02 |

*MW3328 is a compounded aqueous acrylic latex based compound which is proprietary. It is obtained from B. F. Goodrich Corporation, Textile Performance Chemicals Division, Charlotte, N.C.

The coating compound was aerated in a L.E.S.S. Model 5000DH (Dalton, Ga.) foam generator to a blow ratio of 5.96 parts air to 1 part solids content. The solids content can comprise monomer and optionally filler and other auxiliaries as described herein and as known in the art. The pre-polymeric foam was knife coated to the NPPET over foam rubber pad support to a solids coating add-on of 5 to 6% on the weight of the fabric.

The spray coated and foam coated fabric was then dried and cured in a forced air tenter frame oven at a temperature of 204° C. for a dwell time of 1.5 minutes. The composite was then slit to desired dimensions.

The resulting polymeric foam had pore sizes ranging from 3 to 50 microns. The foam penetrated into the fiber matrix of the NPPET to a depth of approximately 0.75 mm (0.0296 in.). The thickness of the entire composite was 0.1036 in. The interface comprising foam intercalated into the substrate made up 29% of the composite by thickness (5% to 6% by weight). The increased density of the foam coated area, i.e., the downstream portion of the substrate, was 18% to 21% greater than the non-coated area of the composite upstream portion of the substrate. Table 7 shows the properties of the resulting cured composite.

TABLE 7

| Precision Fabrics | | | AVERAGE |
|---|---|---|---|
| TEST | METHOD | UNIT | Example A |
| BASIS WEIGHT | INDA 130.0 | OZ./SQ. | 9.55 |
| | | YD. | |
| THICKNESS | INDA 120.0 | MILS | 103.56 |
| FRAZIER AIR | INDA 70.0 | Cubic Ft./ | 119.5 |
| PERMEABILITY | | minute/ | |
| | | Sq. ft. at | |
| | | 125pascal | |
| HANDLEOMETER | INDA 90.0 | GRAMS | 4180 |
| 8 × 8 1″ GAP EQUIVALENT | | MD | |
| GRAB TENSILE | INDA 180.2 | LBS. MD | 119.56 |
| | | LBS. XD | 189.06 |
| MEAN PORE DIAMETER | ASTM E | MICRONS | 28.714 |
| (AUTO CAPILLARY FLOW | 1294 | | |
| POROMETER) | | | |

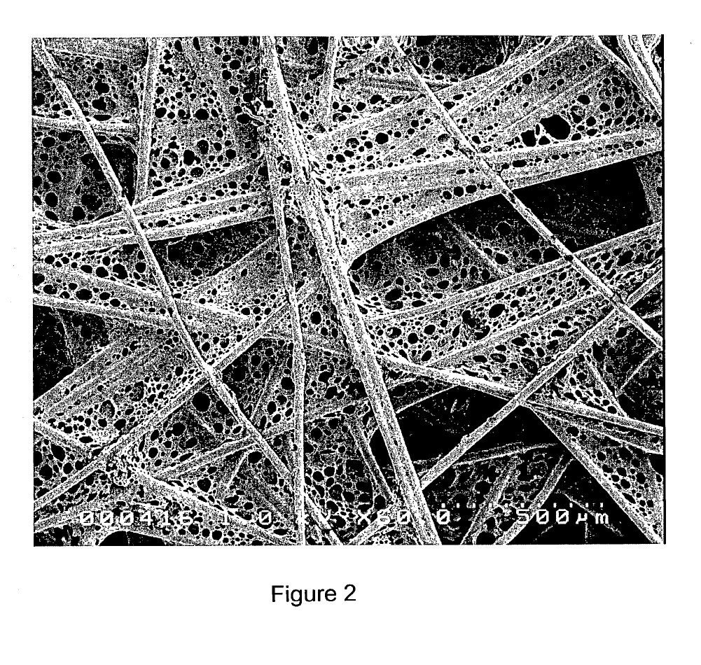

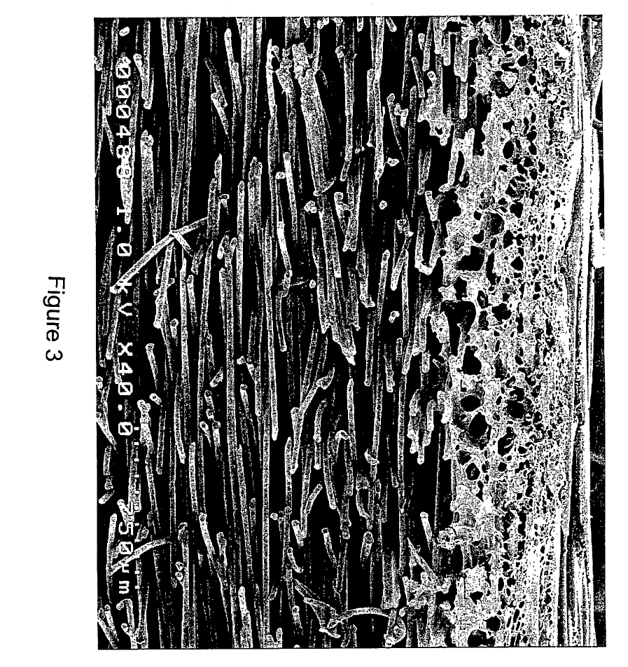

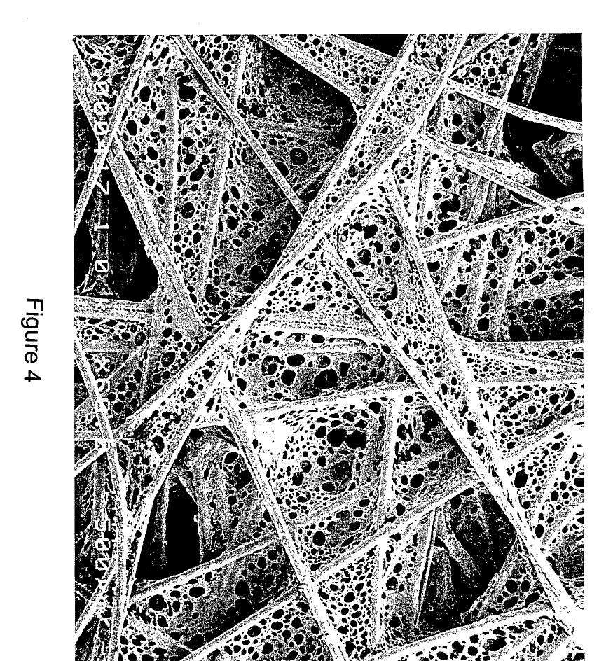

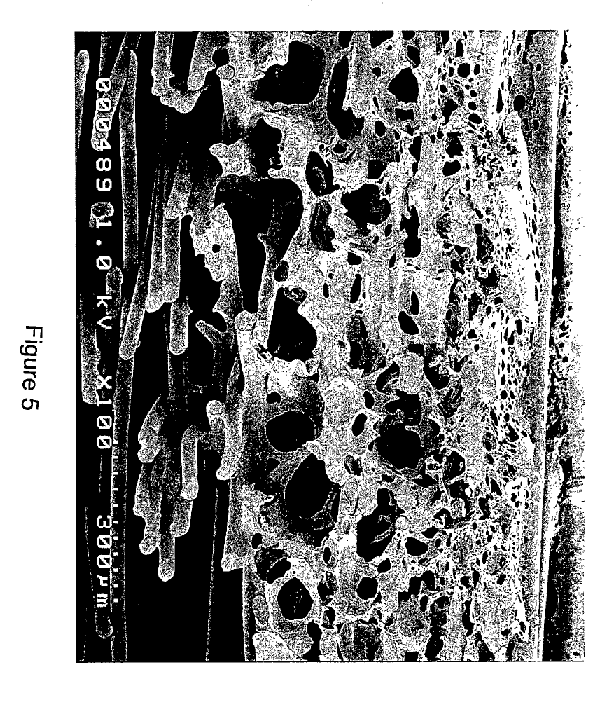

FIGS. 2-5 are SEM micrographs of the filter of Example 1, showing the gradient density foam structure from various angles. FIG. 5 shows a side view of the filter of Example 1, featuring pores of increasing diameter as they progress towards the upstream side (top of photograph) from the downstream side. The gradual increase demonstrates the gradient filtration effect independent of the base substrate structure.

Comparative Data

The filtration efficiency of the filter of Example 1 is compared with two other prior art filters, “Incumbent 1” and “Incumbent 2”. Table 8 shows the physical properties and construction of the filter of Example 1, and the two prior art layers. Incumbent 2 has a much thicker and more complex structure than Incumbent 1.

TABLE 8
Media comparison

| | | | Example | Incumbent | Incumbent |
|---|---|---|---|---|---|
| FILTER media ID.: | | | 1 | #1 | #2 |
| 4/9/01 | | | Precision Fabrics | Competitive auto air | Competitive auto air |
| TEST | METHOD | UNIT | Average | average | average |
| Basis weight: | INDA 130.0 | Oz/sq. yd. | 9.55 | 7.13 | 13 |
| Relative complexity: | | layers | One layer | 3 layers | −6 layers |
| Relative economics: | | X cost | 0.75X | X | 2X |
| Thickness: | INDA 120.0 | Inches | 0.104 | 0.109 | 0.133 |
| Frazier air permeability | INDA 70.0 | CFM | 120 | 152 | 53 |
| Handleometer (8″ × | INDA 90.0 | Grams MD | 4180 | 1400 | 1800 |
| 8″ − 1″ gap) | | | | | |
| CONSTRUCTION | | | | | |
| ANALYSIS | | | | | |
| Fiber size (microscopical | AATCC 20A-1981 | denier | 3, 6 | 1.5, 5 to 7 | 1.2, 2.5 to 13 |
| analysis) | | | | | |
| Down stream side | Dissection | Layer #1 | *PET fiber gradient density | Coated composite | Spunbond |
| composition | | | | | |
| (general description) | AATCC 20-1980 | | needle punch nonwoven*/ | resin-bonded | point bond |
| | | | intercalated porous foam | nonwoven-cellulose, | Polyester (PET) nonwoven |
| | | | structure coating layer | polyester | |
| Center composition | Dissection | Layer #2 | *PET fiber g.d. Needlepunch/ | Carded NW bat | High density needled PET bats |
| (general description) | AATCC 20-1980 | | resinated pleat finish | cellulose, PET | laminated to layer #1 |
| Upstream composition | Dissection | Layer #3 | same as #2 | Carded nonwoven bat | Lower density needled |
| (general description) | AATCC 20-1980 | | NOTE: Entire structure is a | that is needle punched. | polyester bats laminated to |
| | | | substrate base that is one | Composed of polyester | Layer #2 |
| | | | layer and subjected to a | and cellulose with | |
| | | | finishing process. | resin Treatment. | |
| | | | | NOTE: multiple fabric | NOTE: Multiple fabric |
| | | | | and process product | and process product |
| Mean pore diameter | ASTM E 1294 | Microns | 28.714 | 42.414 | 23.222 |

FIGS. 1(a)-(c) schematically illustrates the structural composition of the single-layered filter of Example 1 compared to that of the two prior art filters. As discussed previously, FIG. 1(a) shows a single-layered structure comprising intercalated, higher density portion 4, and nonintercalated, lower density portion 5. Low density portion 5 in the filter of Example 1 is a needled felt. FIG. 1(b) shows a schematic exploded view of prior art filter Incumbent 1, which is four-layered structure, schematically shown as filter 12. The layers are shown in decreasing density from top to bottom. Filter 12 comprises two low density layers 14, which are carded nonwoven bats needled to high density layers 15. Layers 15 are resin bonded nonwovens, which are needled together. FIG. 1(c) shows a schematic exploded view of prior art filter Incumbent 2, which is six-layered structure, schematically shown as filter 22. The layers are shown in decreasing density from top to bottom. Filter 22 comprises three low density needled nonwoven bat layers 24 and a medium density needled nonwoven bat layer 25. Layer 26 is a high density needled nonwoven resin bond and bat layer. Layer 27 is a high density spunbonded nonwoven laminated to layer 26.

Tables 9 and 10 provide filtration efficiencies of the filter of Example 1 with the two prior art filters for fine dust (Table 9) and coarse dust (Table 10). Tables 11 and 12 provide comparative average initial and final efficiencies for the filter of Example 1 for the fine dust (Table 11) and coarse dust (Table 12) samples. From this data, it can be seen that the filter of Example 1 has higher final efficiencies compared to Incumbent 1. The filter of Example 1 also has comparable final efficiencies compared to Incumbent 2, despite the fact that Incumbent 2 is 36% heavier, 28% thicker, has twice the cost, and has a more complex design.

TABLE 9
Test Report: % efficiency @ relative particle sizes - ISO FINE DUST, A2

Date: 10/5/00
Test Method: Retention and Capacity per SAE J726, modified
Instrumentation: 1230 Sensor, S/N 93100199
Fluid: Air
Flow Rate: Face Velocity: 100 fpm
Temperature: Ambient
Contaminant: ISO Fine, A2
Description of Samples: Flat sheet media
Date Received: 8/11/00

| | initial microns: | | | | | | |
|---|---|---|---|---|---|---|---|
| | 0.3-0.4 | 0.4-0.5 | 0.5-0.6 | 0.6-0.8 | 0.8-1 | 1-3 | 3-5 |
| Fine dust SAE | | | | | | | |
| Example 1 | 23.39 | 29.77 | 34.70 | 37.04 | 37.53 | 37.77 | 40.7 |
| Incumbent #1 | 18.26 | 20.67 | 22.76 | 25.55 | 24.77 | 25.42 | 33.6 |
| Incumbent #2 | 19.71 | 24.35 | 30.59 | 34.06 | 34.87 | 35.35 | 39.3 |
| | final microns: | | | | | | |
| | 0.3-0.4 | 0.4-0.5 | 0.5-0.6 | 0.6-0.8 | 0.8-1 | 1-3 | 3-5 |
| Example 1 | 89.69 | 95.51 | 96.20 | 95.93 | 95.98 | 95.14 | 88.45 |
| Incumbent #1 | 86.88 | 94.12 | 95.78 | 95.59 | 95.84 | 95.29 | 92.11 |
| Incumbent #2 | 92.81 | 97.66 | 98.45 | 98.32 | 98.35 | 98.95 | 99.37 |

TABLE 10
Test Report: % Efficiency @ relative particle sizes - ISO COARSE DUST, A4

Date:
10/5/00
Test Method: Retention and Capacity per SAE J726, modified
Instrumentation: 1230 Sensor, S/N 93100199
Fluid: Air
Flow Rate: Face Velocity: 100 fpm
Temperature: Ambient
Contaminant: ISO Coarse, A4
Description of Samples: Flat sheet media
Date Received: 8/11/00

| initial eff. mircons | | | | | | | |
|---|---|---|---|---|---|---|---|
| 0.3-0.4 | 0.4-0.5 | 0.5-0.6 | 0.6-0.8 | 0.8-1 | 1-3 | 3-5 | >5 |

Coarse dust SAE

| Example 1 | 24.79 | 25.87 | 35.04 | 37.78 | 46.94 | 48.48 | 78.5 | 95.3 |
|---|---|---|---|---|---|---|---|---|
| Incumbent #1 | 4.51 | 7.37 | 10.06 | 11.50 | 17.49 | 16.92 | 47.2 | 65.4 |
| Incumbent #2 | 15.46 | 20.29 | 22.95 | 26.52 | 26.86 | 25.15 | 36.4 | 34.0 |
| | final eff. microns | | | | | | | |
| | 0.3-0.4 | 0.4-0.5 | 0.5-0.6 | 0.6-0.8 | 0.8-1 | 1-3 | 3-5 | >5 |
| Example 1 | 77.99 | 92.83 | 95.05 | 95.27 | 93.77 | 91.49 | 84.0 | 86.4 |
| Incumbent #1 | 83.92 | 92.64 | 90.42 | 85.26 | 78.65 | 52.61 | 52 | 52 |
| Incumbent #2 | 97.78 | 97.70 | 98.74 | 99.02 | 98.82 | 99.29 | 99.8 | 100.0 |

TABLE 11

| | | How | | How |
|---|---|---|---|---|
| SAE J726 ISO | | Example 1 | | Example 1 |
| fine, A2 dust | Average | Compares to | Average final | Compares to |
| SAMPLE | initial % eff. | incumbents (%) | % efficiency | incumbents (%) |
| Example “A” | 34.41 | | 93.84 | |
| Incumbent #1 | 24.43 | A is 40.9% more | 93.67 | A is equal to #1 |
| | | efficient than 1 | | |
| Incumbent #2 | 31.18 | A is 10.4% more | 97.7 | A is slightly less efficient |
| | | efficient than 2 | | than #2 |

TABLE 12

| | | How | | How |
|---|---|---|---|---|
| SAE J726 ISO | | Example 1 | | Example 1 |
| coarse, A4 dust | Average | Compares to | Average final | Compares to |
| SAMPLE | initial % eff. | incumbents (%) | % efficiency | incumbents (%) |
| Example “A” | 49.09 | | 89.6 | |
| Incumbent #1 | 22.56 | A is 117.6% more | −22.31 | A is five times more |
| | | efficient than 1 | | efficient than #1 |
| Incumbent #2 | 25.95 | A is 89.2% more | 98.89 | A is slightly less |
| | | efficient than 2 | | efficient than #2 |

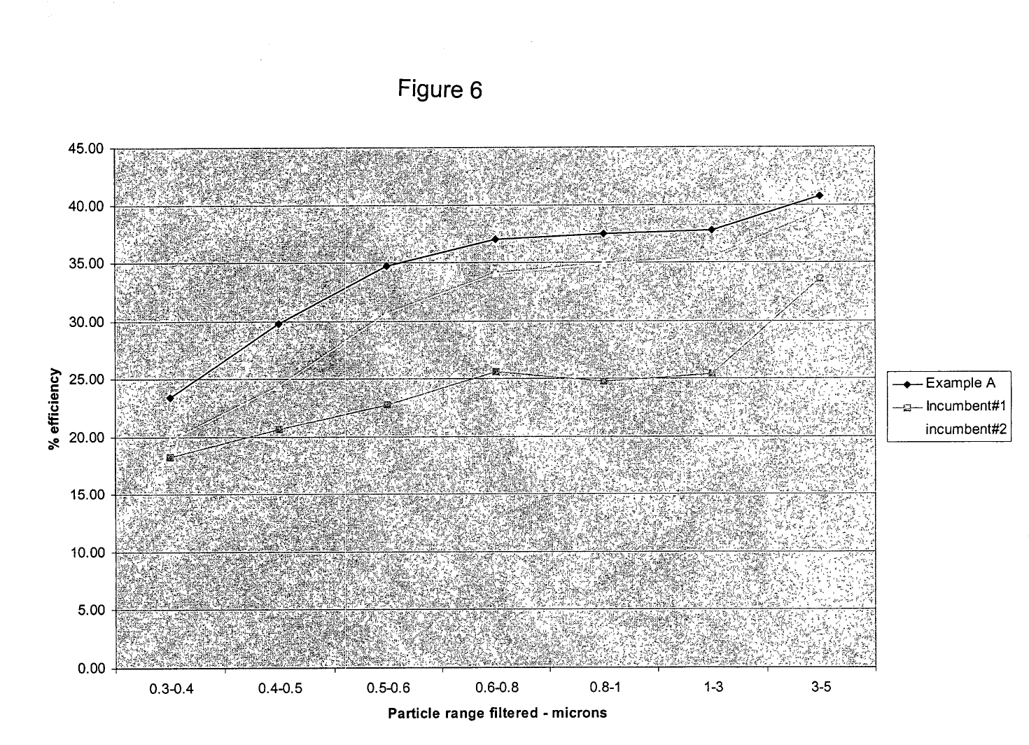

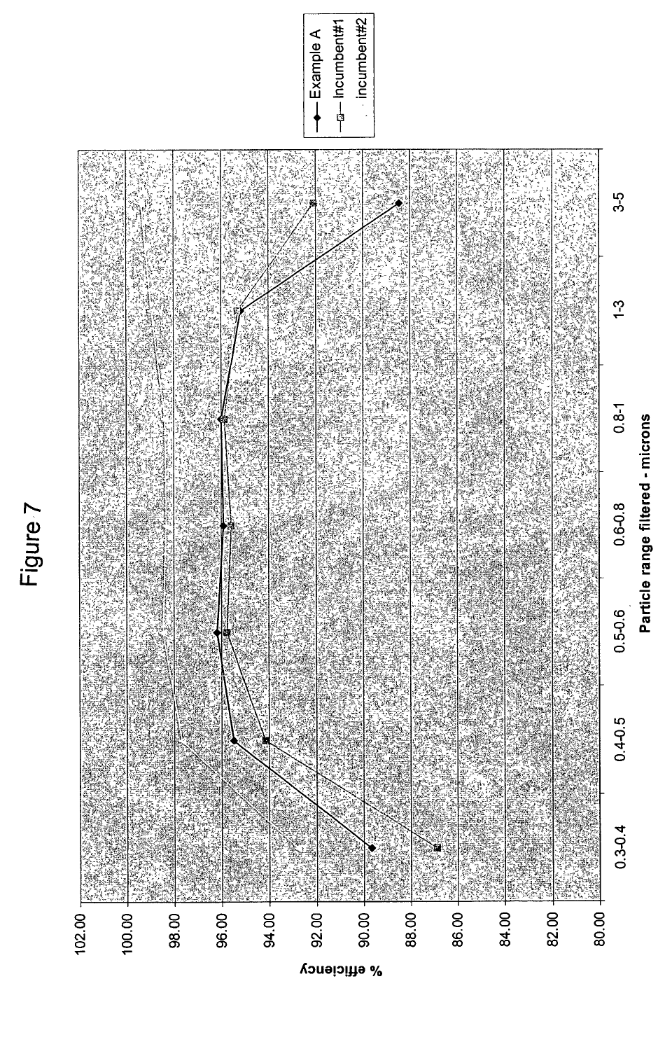

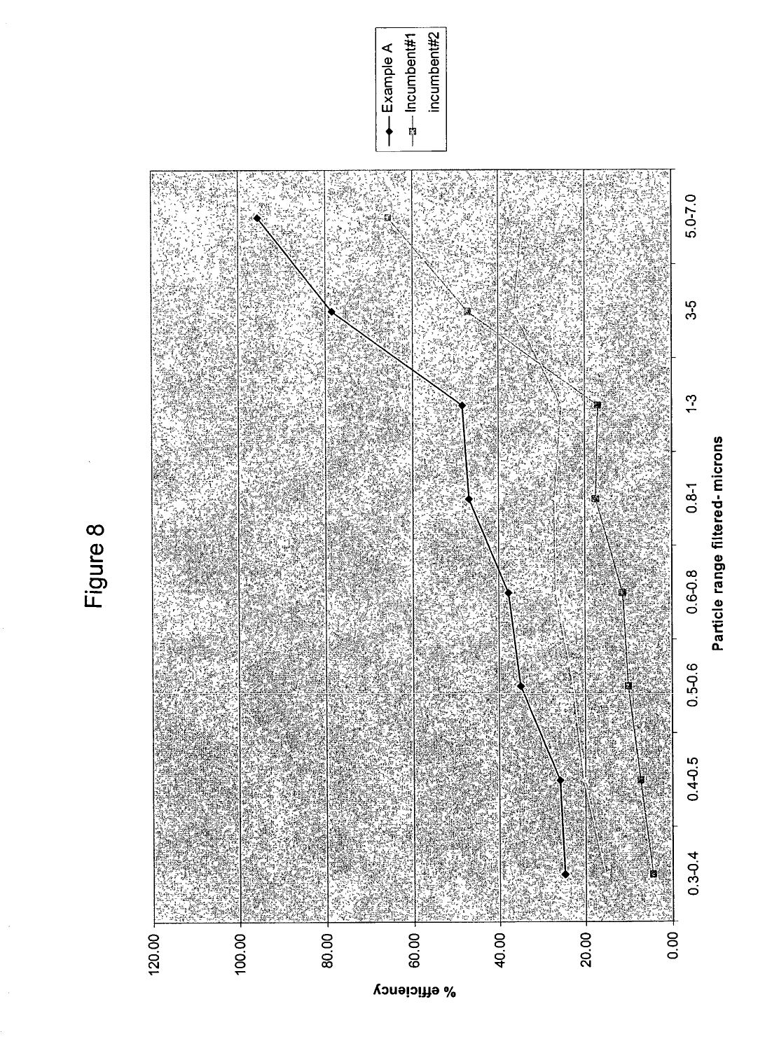

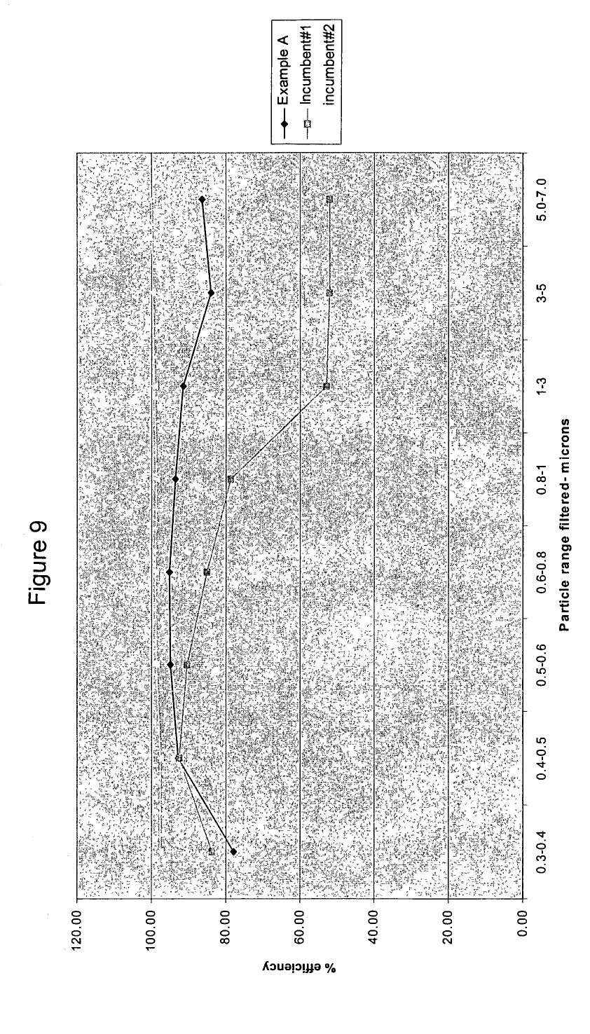

FIGS. 6-9 provide graphical representations comparing average initial and final efficiencies for the filter of Example 1 for the fine dust (Table 11) and course dust (Table 12) samples. It can be seen that the filter of Example 1 consistently provides improved or comparable performance with the prior art filters while featuring a simpler design.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An air filter comprising a porous substrate, a portion of the substrate being intercalated with a polymeric foam, wherein the filter has a downstream side and a density gradient across its thickness.

2. The air filter of claim 1, wherein the air filter comprises a single layer.

3. The air filter of claim 1, wherein the intercalated portion has a density greater than the density of the portion that is not intercalated by about 5% to about 50%.

4. The air filter of claim 3, wherein the intercalated portion has a density greater than the density of the portion that is not intercalated by about 5% to about 40%.

5. The air filter of claim 1, wherein the thickness of the intercalated portion ranges from about 5% to about 80% of the thickness of the filter.

6. The air filter of claim 5, wherein the thickness of the intercalated portion ranges from about 5% to about 60% of the thickness of the filter.

7. The air filter of claim 1, wherein the intercalated portion is the downstream side of the filter.

8. The air filter of claim 1, wherein the substrate is a layer and the intercalated portion is disposed on one side of the layer and the portion that is not intercalated is disposed on the opposite side of the layer.

9. The air filter of claim 8, wherein the side of the substrate layer comprising the portion that is not intercalated is coated with a finish, for imparting dimensional stability to the substrate.

10. The air filter of claim 1, wherein the substrate is non-woven.

11. The air filter of claim 10, wherein the substrate is chosen from: needled felts made from polyester, polypropylene, viscose, rayon, polyethylene, and aramids; needled spun-bonded polyester; spunlace PET, Nomex®, and Kevlar®; spunbonded nonwovens made from PET, nylon, polypropylene, and polyethylene; thermally bonded nonwovens; and resin bonded nonwovens

12. The air filter of claim 1, wherein the substrate is a needle-punched layer such that one side of the layer is smooth relative to the opposing side.

13. The air filter of claim 12, wherein the intercalated portion is disposed on the smooth side of the substrate layer.

14. The air filter of claim 1, wherein the substrate is chosen from needlepunched, spunlaced, hydroentangled, melt blown, spunbonded, thermal bonded, point bonded, resin bonded, and airlaid substrates, and combinations and composites thereof.

15. The air filter of claim 14, wherein the substrate is chosen from (1) spunbonded meltblown spun bonded substrates, and (2) spunbonded and needlepunched substrates.

16. The air filter of claim 1, wherein the intercalated portion has a mean pore size less than about 50 μm, as measured according to ASTM E 1294.

17. The air filter of claim 16, wherein the intercalated portion has a mean pore size ranging from about 0.3 μm to about 50 μm, as measured according to ASTM E 1294.

18. The air filter of claim 1, wherein the portion that is not intercalated has a mean pore size of at least about 50 μm, as measured according to ASTM E 1294.

19. The air filter of claim 18, wherein the portion that is not intercalated has a mean pore size ranging from about 50 μm to about 500 μm, as measured according to ASTM E 1294.

20. The air filter of claim 1, wherein the filter has a Frazier air permeability ranging from about 20 to about 400 ft³/minf² at 125 pascal, as measured according to INDA 70.0.

21. The air filter of claim 20, wherein the filter has a Frazier air permeability ranging from about 50 to about 150 ft³/min/ft² at 125 pascal, as measured according to INDA 70.0.

22. The air filter of claim 1, wherein the thickness of the filter ranges from about 5 to about 200 mils, as measured according to INDA 120.0.

23. The air filter of claim 1, wherein the thickness of the filter ranges from about 50 to about 150 mils, as measured according to INDA 120.0.

24. The air filter of claim 1, wherein the substrate has a basis weight ranging from about 0.5 oz/sq. yard to about 20 oz/sq. yard, as measured according to INDA 130.0.

25. The air filter of claim 1, wherein the filter is pleated.

26. A composite comprising:
a porous substrate layer; and
a polymeric foam permeating throughout one side of the substrate layer, the composite having a density gradient across its thickness,
wherein the composite is capable of filtering airborne particles.

27. The composite of claim 26, wherein the particles have a size of at least about 0.1 μm.

28. The composite of claim 26, wherein the particles have a size of less than about 1000 μm.

29. The composite of claim 26, wherein the composite has an upstream portion comprising pores of sufficient size to allow particles having a size of up to about 1 μm to pass through.

30. An air filter comprising:
a fibrous substrate; and
a polymeric foam intercalated with fibers of the substrate, wherein the filter has a density gradient across its thickness.

31. A method for filtering air, comprising:
allowing air comprising airborne particles to pass through a single-layer composite comprising:
a porous substrate; and
a polymeric foam intercalated with one side of the substrate layer,
wherein the composite has a density gradient across its thickness.

32. The method of claim 31, wherein the air is first passed through the side of the substrate layer that is not intercalated.

33. The method of claim 31, wherein airborne particles having a size less than 10 μm is allowed to pass through the side of the substrate layer that is not intercalated

34. A method of making an air filter, comprising:
providing a porous substrate layer;
applying a layer of a prepolymeric foam to the substrate layer; and
drying and curing the prepolymeric foam to produce a polymeric foam interspersed throughout at least a portion of the substrate.

35. The method of claim 34, wherein the prepolymeric foam has a viscosity ranging from 50 to 20,000 cps, as measured by Brookfield Model RVT, spindles 1-7 rμm, 72° F.

36. The method of claim 34, wherein an application temperature of the prepolymeric foam ranges from about 60° F. to about 120° F.

37. The method of claim 34, wherein the prepolymeric foam is dried at temperatures ranging from about 150° F. to about 430° F.

38. The method of claim 34, wherein the prepolymeric foam is cured at temperatures ranging from 250° F. to 450° F.

39. The method of claim 34, wherein drying and/or curing have dwell times of at least about 25 seconds.

40. The method of claim 34, wherein applying the layer of prepolymeric foam to the substrate causes the prepolymeric foam to intersperse throughout at least a portion of the substrate.

41. The method of claim 34, wherein the air filter is subjected to at least one treatment chosen from crushing, calendering and treatments with at least one property modifier.

42. The method of claim 41, wherein the at least one property modifier is chosen from water repellants, biocides, fungicides, deodorizers, tackifiers, antistats, oleophilic agents, oleophobic agents, flame retardants, antioxidants, U.V. stabilizers, pigmentation dyes or prints, triboelectric constructions, corona or plasma treatments, and gas adsorption agents.

43. The method of claim 41, wherein the at least one property modifier is applied by at least one technique chosen from dip and nip pad, kiss roll, spray booth, and froth finishing applicators.

44. An air filter comprising a single porous layer having a density gradient across the thickness of the layer.

45. An air filter comprising a porous substrate that is intercalated with a polymeric foam, wherein the filter has a density gradient across its thickness.
